(19) United States
(12) Patent Application Publication
(10) Pub. No.: US 2025/0122906 A1
(43) Pub. Date: Apr. 17, 2025

(54) CAGE FOR BALL BEARING AND BALL BEARING COMPRISING SAME

(71) Applicant: ILJIN GLOBAL Co.,Ltd, Seoul (KR)

(72) Inventors: Ji Wook CHOI, Incheon (KR); Chang Ki LEE, Seoul (KR); Hyeon Soo LIM, Hwaseong-si Gyeonggi-do (KR); Woon Ju LEE, Yongin-si Gyeonggi-do (KR)

(73) Assignee: ILJIN GLOBAL Co.,Ltd, Seoul (KR)

(21) Appl. No.: 18/989,837

(22) Filed: Dec. 20, 2024

Related U.S. Application Data
(63) Continuation of application No. PCT/KR2023/010779, filed on Jul. 25, 2023.

(30) Foreign Application Priority Data
Jul. 25, 2022 (KR) 10-2022-0092078

(51) Int. Cl. F16C 33/38; F16C 33/66

(52) U.S. Cl. CPC F16C 33/3887; F16C 33/6681

(57) ABSTRACT

A cage for a ball bearings is provided. A cage for a ball bearing includes a cage main body formed to have a ring shape; a plurality of partitions which each extend in an axial direction of the cage main body and are formed spaced apart in a circumferential direction of the cage main body; and ball support parts which are formed to extend in the axial direction from an opposite end portion of the cage main body in each of the plurality of partitions. Pockets are formed between the plurality of partitions adjacent to each other, and oil storage parts are formed on at least one of the outer surface and the inner side in a radial direction of the plurality of partitions so that oil stored in the oil storage parts is supplied to the pocket.

### CROSS-REFERENCE TO RELATED APPLICATIONS

This application is a continuation of International Application No. PCT/KR2023/010779 filed on Jul. 25, 2023, which claims priority to Korean Patent Application No. 10-2022-0092078 filed on Jul. 25, 2022, the entire contents of which are herein incorporated by reference.

### TECHNICAL FIELD

The present disclosure relates to a cage for a ball bearing and a ball bearing including the same, and more particularly to a cage for a ball bearing with improved lubrication and a ball bearing including the same.

The present disclosure has been derived from a study conducted as Material Component Technology Development Project of Korea Evaluation Institute of Industrial Technology of Ministry of Trade, Industry and Energy [Project Number: 1415179692, Research Subject Name: 20000 RPM P5 class high precision bearing design and manufacturing technology development for electric vehicles].

### BACKGROUND ART

In recent years, a demand for eco-friendly vehicles including electric vehicles has been rapidly increasing due to factors such as strengthening environmental regulations and fuel efficiency regulations and rising oil prices. The drive systems of electric vehicles are configured to include an electric motor and a reducer. In addition, with the increase in demand for electric vehicles, technique development for high-speed and high-output of drive systems of electric vehicles is also actively underway. For example, techniques which increase the rotation speeds of electric motors are being developed to improve efficiency by increasing the specific outputs of the electric motors.

In line with the trend toward higher speeds in the drive systems of such electric vehicles, bearings used in electric motors and reducers also need to be designed to be suitable for high-speed rotation. Moreover, as the needs for low torque, low friction, and low noise increase, bearing design which takes these into account is also necessary.

A ball bearing that is a type of rolling bearing is mainly used as bearings for high-speed rotation. A ball bearing has two raceway rings (inner and outer rings) and a plurality of balls as rolling elements which roll between them. Thus, the contact area between the rolling elements and the raceway rings is relatively small, making it suitable for high-speed rotation.

The ball bearing further includes a cage which maintains a plurality of balls at a predetermined interval along the circumference of the raceway rings. In such ball bearings, lubricating oil typically flows between the two raceway rings and the cage to lubricate the raceway surfaces and rolling elements.

Here, when a ball bearing rotates at high speed, the presence of the cage may prevent smooth lubrication of the raceway surfaces and rolling elements, which may result in increased friction and noise. Particularly, at the time of starting a vehicle without lubricating oil being supplied to the inside of the ball bearing, there is a risk of premature damage to the bearing due to the large frictional heat generated.

Furthermore, if a ball bearing rotates at high speed, the cage may become deformed due to centrifugal force or the like, and as a result, there are matters in that it cannot perform a function thereof of holding the ball.

### DISCLOSURE

### Technical Problem

The present disclosure is intended to solve the matters in the related art as stated, and the present disclosure is for the purpose of providing a cage for a ball bearing and a ball bearing with improved lubrication.

In addition, the present disclosure is also for the purpose of providing a cage for a ball bearing and a ball bearing which are capable of preventing deformation of the cage even at high speed rotation.

### Technical Solution

Representative configurations of the present disclosure to achieve the above-described purposes are as follows.

According to an example embodiment of the present disclosure, a cage for a ball bearing is provided. A cage for a ball bearing according to an example embodiment of the present disclosure may comprise: a cage main body formed to have a ring shape; a plurality of partitions which each extend in an axial direction of the cage main body and are formed spaced apart in a circumferential direction of the cage main body; and ball support parts which are formed to extend in the axial direction from an opposite end portion of the cage main body in each of the plurality of partitions. According to an example embodiment of the present disclosure, pockets are formed between the plurality of partitions adjacent to each other, and oil storage parts are formed on at least one of the outer surface and the inner side in a radial direction of the plurality of partitions so that oil stored in the oil storage parts is supplied to the pocket.

According to an example embodiment of the present disclosure, the oil storage part may have an inclined surface inclined in a direction in which it is away from the cage main body.

According to an example embodiment of the present disclosure, inclined surface of the oil storage part may be formed in such a way that a thickness of partition increases in the direction in which it is away from the cage main body.

According to an example embodiment of the present disclosure, an angle of inclination of a slope of the oil storage part 121 and 122 with respect to the axial direction may be 5° or less.

According to an example embodiment of the present disclosure, a pair of lateral walls may be formed on at least one of the outer surface and the inner side in the radial direction of the plurality of partitions and disposed to be spaced apart in the circumferential direction, and the oil storage parts may be defined by the cage main body and the pair of lateral walls.

According to an example embodiment of the present disclosure, heights of the oil storage parts which are defined as a distance from the bottom surface of the cage main body to the end portions of a pair of lateral walls may be formed smaller than a height of a ball center which is defined as a distance from the bottom surface of the cage main body to the center of the ball seated in the pocket.

According to an example embodiment of the present disclosure, first oil storage parts may be formed on the outer surface in the radial direction of the plurality of partitions and second oil storage parts may be formed on the inner surface in the radial direction of the plurality of partitions.

A cage for a ball bearing according to an example embodiment of the present disclosure may further comprise a weight loss part formed as a groove in the circumferential direction on the bottom surface of the cage main body.

According to an example embodiment of the present disclosure, a ball bearing is provided. A ball bearing according to an example embodiment of the present disclosure may comprise an inner ring; an outer ring which is disposed opposite the inner ring; a plurality of balls which is disposed between the inner ring and the outer ring and spaced apart from each other at a predetermined interval; and the above-described cage which is disposed between the inner ring and the outer ring and configured to maintain the plurality of balls at a predetermined interval.

In addition, a cage for a ball bearing and a ball bearing according to the present disclosure may further comprise other additional configurations without departing from the technical sprit of the present disclosure.

### Advantageous Effects

According to the present disclosure, it is possible to improve lubrication by smoothly supplying lubricating oil even when a ball bearing rotates at high speed. Particularly, according to the present disclosure, it is possible to supply oil stored in an oil storage part to a ball even at the initial start-up, thereby reducing friction and suppressing the generation of frictional heat.

Also, according to the present disclosure, by reducing a weight of a cage for a ball bearing, it is possible to reduce a centrifugal force even when the ball bearing rotates at high speed, thereby preventing cage deformation.

### BRIEF DESCRIPTION OF DRAWINGS

FIG. 1 exemplarily shows a cage according to an example embodiment of the present disclosure.

FIG. 2 exemplarily shows a perspective view of a rear surface of the cage according to an example embodiment of the present disclosure.

FIG. 3 exemplarily shows a plan view of the cage according to an example embodiment of the present disclosure.

FIG. 4 exemplarily shows a cross-sectional view taken along line A-A of FIG. 3.

FIG. 5 shows an enlarged view of portion B of FIG. 4.

FIG. 6 exemplarily shows balls supported in the cage according to an example embodiment of the present disclosure.

FIG. 7 exemplarily shows a partition of the cage according to an example embodiment of the present disclosure when viewed from the outside.

FIG. 8 exemplarily shows the partition of the cage according to an example embodiment of the present disclosure when viewed from the inside.

FIG. 9 exemplarily shows lubrication performed on an outer side of the partition of the cage according to an example embodiment of the present disclosure.

FIG. 10 exemplarily shows lubrication performed on an inner side of the partition of the cage according to an example embodiment of the present disclosure.

### DETAILED DESCRIPTION OF THE INVENTION

A case for a ball bearing comprising: a cage main body formed to have a ring shape; a plurality of partitions which each extend in an axial direction of the cage main body and are formed spaced apart in a circumferential direction of the cage main body; and ball support parts which are formed to extend in the axial direction from an opposite end portion of the cage main body in each of the plurality of partitions, in which pockets are formed between the plurality of partitions adjacent to each other so that a ball is seated therein, and oil storage parts are formed on at least one of the outer surface and the inner side in a radial direction of the plurality of partitions so that oil stored in the oil storage parts is supplied to the pocket.

### Modes of the Invention

Embodiments which will be described below are provided for the purpose of explaining the technical ideas of the present disclosure and the scope of the rights of the present disclosure is not limited to the embodiments which will be presented below or the specific descriptions thereof.

All technical and scientific terms used herein, unless otherwise defined, have the meaning commonly understood by a person of ordinary skill in the art to which the present disclosure belongs and all terms used herein have been selected for the purpose of more clearly describing the present disclosure and have not been selected to limit the scope of the rights of the present disclosure.

The expressions “comprising,” “including,” “having,” and the like, as used herein, needs to be understood as open-ended terms implying the possibility of including other embodiments, unless otherwise stated in the phrase or sentence in which the expression is included.

In this specification, an “axial direction” means a direction of extension of a central axis about which a cage for a ball bearing rotates, a “radial direction” means a direction perpendicular to the “axial direction” and moving away from or closer to the central axis, and a “circumferential direction” means a direction of rotation centered on the “axial direction”.

The singular forms used in this specification may include a plurality of meanings unless otherwise stated and the same applies to the singular forms used in the claims.

When it is said herein that a constituent element is “positioned” or “formed” on one side of another constituent element, it needs to be understood that the constituent element may be positioned or formed in direct contact with one side of the other constituent element or may be positioned or formed with another new constituent element interposed therebetween.

Preferred embodiments of the present disclosure are described in detail below with reference to the attached drawings to a degree that a person having ordinary skill in the art to which the present disclosure belongs may easily practice the present disclosure. In the attached drawings, the same or corresponding constituent elements are indicated by the same reference numerals, and in the descriptions of the embodiments which will be described below, duplicate description of the same or corresponding constituent elements may be omitted. Here, even if a description of a particular constituent element is omitted in the description below, it is not intended that such constituent element is not included in the embodiment.

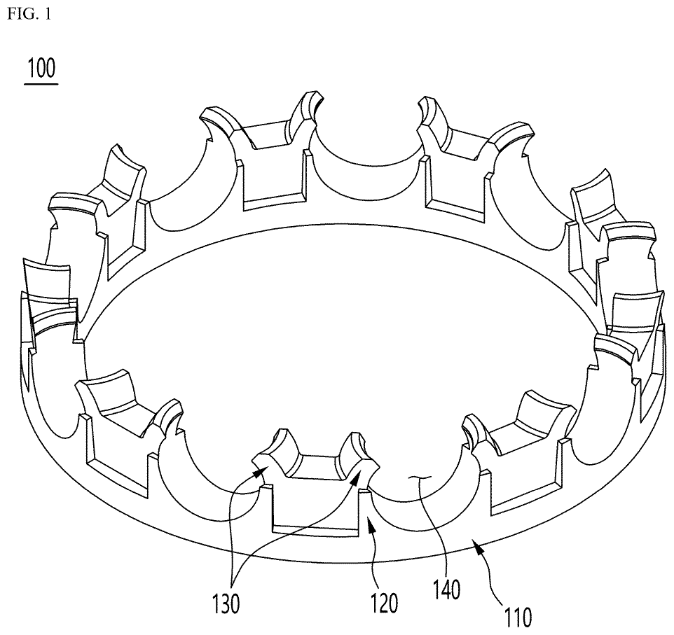

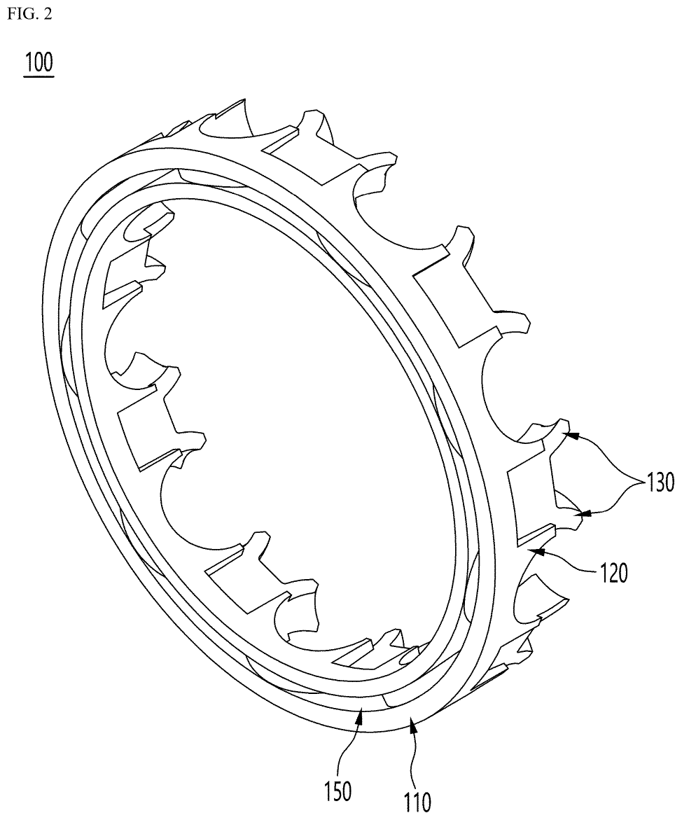

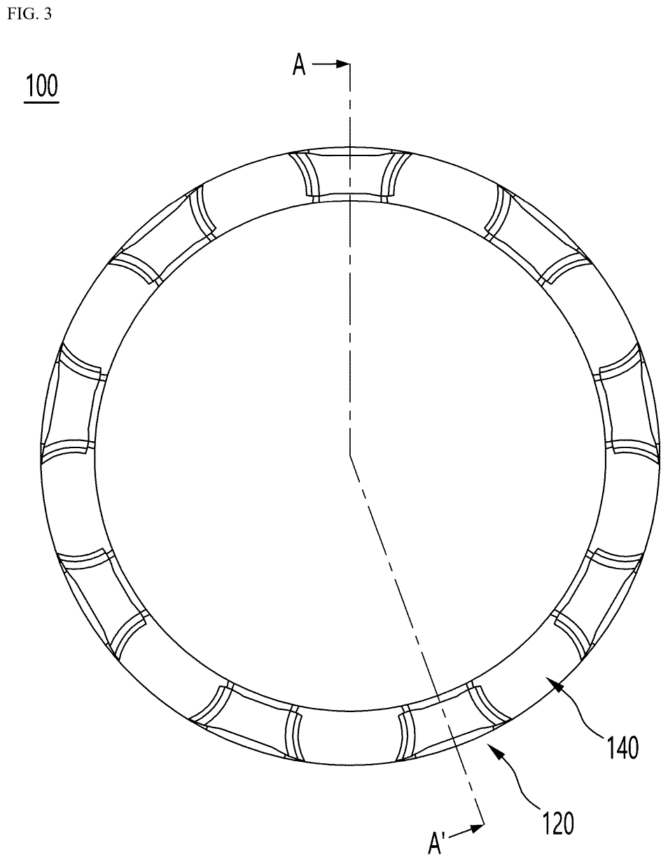

FIG. 1 exemplarily shows a cage according to an example embodiment of the present disclosure, FIG. 2 exemplarily shows a perspective view of a rear surface of the cage according to an example embodiment of the present disclosure, and FIG. 3 exemplarily shows a plan view of the cage according to an example embodiment of the present disclosure.

A cage 100 according to an example embodiment of the present disclosure may be a cage used for a ball bearing. Referring to FIGS. 1 to 3, the cage 100 may comprise a cage main body 110, partitions 120, and ball support parts 130.

According to an example embodiment of the present disclosure, the cage main body 110 may be formed to have a ring shape and may form a basic structure of the cage 100.

According to an example embodiment of the present disclosure, the partitions 120 may be formed to extend in an axial direction of the cage main body 110 and may be formed in a plurality of places spaced apart in a circumferential direction of the cage main body 110. An oil storage part(s) may be formed on at least one of an outer side surface and an inner side surface in a radial direction of the partition 120. The oil storage partmay be configured to capture and store oil and supply oil to pockets 140 which will be described later, thereby smoothly supplying oil to the ball and reducing friction. The detailed configuration of the oil storage part will be described later.

According to an example embodiment of the present disclosure, the ball support parts 130 may each be formed to extend axially from one end portion of each partition 120. Specifically, the ball support part 130 may be formed at an end portion opposite to the cage main body 110 in the axial direction in the partition 120 and a pair of ball support parts 130 spaced apart in the circumferential direction may be formed for each of the partitions 120.

According to an example embodiment of the present disclosure, the pocket 140 may be formed between the plurality of partitions 120 adjacent to each other in the circumferential direction. The pocket 140 is configured to have a ball that is a moving object seated therein and may be formed as a curved surface of approximately spherical shape. The ball support part 130 described above may be disposed on an upper portion of the pocket 140 to support the ball when the ball is seated.

According to an example embodiment of the present disclosure, a weight loss part 150 may be formed in the cage main body 110. As shown in FIG. 2, the weight loss part 150 may be formed on a lower surface of the cage main body 110, that is, on the opposite side in which the partition 120 is formed, and may be composed of a plurality of grooves which are formed spaced apart from each other approximately in the circumferential direction. For example, a plurality of grooves forming the weight loss part 150 can be formed at positions corresponding to the plurality of partitions 120.

A weight of the cage 100 may be reduced due to the weight loss part 150, which may lead to a reduction in a centrifugal force acting on the cage 100 when the ball bearing in which the cage 100 is installed rotates at high speed. That is to say, the weight of the cage 100 may be reduced due to the weight loss part 150 and deformation due to a centrifugal force may be prevented.

Although the example embodiment illustrates that the weight loss part 150 is formed of the plurality of grooves at positions corresponding to the partition 120 on a bottom surface of the cage main body 110, the present disclosure is not limited thereto. For example, the weight loss part 150 may be formed as a single long groove extending circumferentially on the bottom surface of the cage main body 110.

As described above, the present disclosure is characterized by having oil storage parts in the cage to smoothly supply lubricating oil to the ball that is a rolling element and reduce friction. A configuration of the oil storage part of the cage will be described in detail below with reference to the drawings.

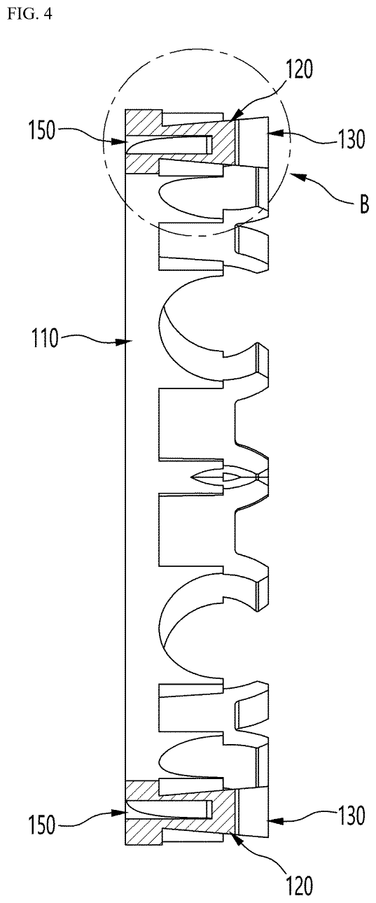

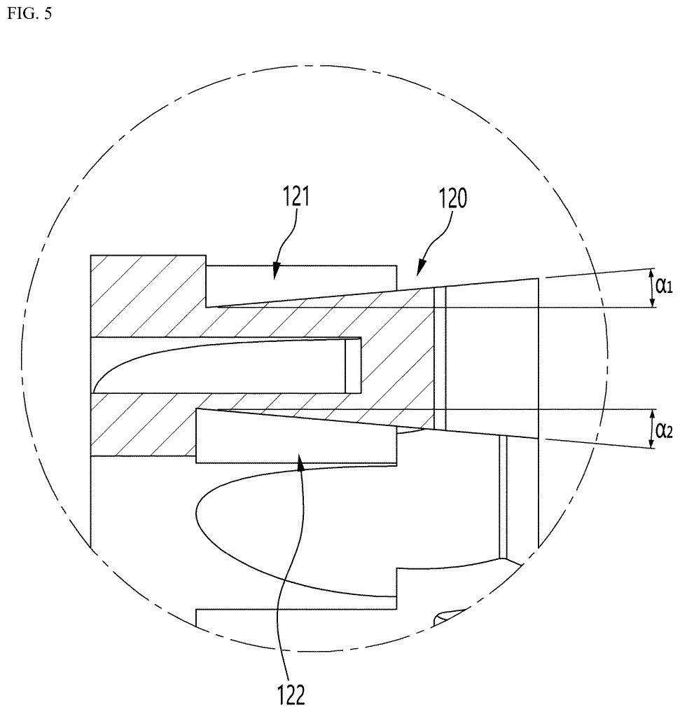

FIG. 4 exemplarily shows a cross-sectional view taken along line A-A of FIG. 3 and FIG. 5 shows an enlarged view of a cross-sectional view of portion B of FIG. 4, that, a partition portion.

Referring to FIGS. 4 and 5, a first oil storage part 121 and a second oil storage part 122 may be formed on an outer surface and an inner surface of the partition 120 according to an example embodiment of the present disclosure, respectively. The oil storage parts 121 and 122 are grooves formed in the partition 120 and may provide a space for capturing and storing oil. On the other hand, although it is described in the example embodiment that the oil storage part is formed on each of the outer surface and the inner surface of the partition 120, it is also included in the scope of the present disclosure that the oil storage part is formed on only one of the outer surface and inner surface of the partition 120.

According to an example embodiment of the present disclosure, the first oil storage part 121 may be formed on the outer surface of the partition 120 and may be formed to have an inclined surface. Specifically, the first oil storage part 121 may be formed to be inclined in a direction in which it is away from the cage main body 110 with respect to the axial direction. More specifically, the first oil storage part 121 may be formed so that an internal space becomes smaller in the direction in which it is away from the cage main body 110 in the axial direction. In other words, a slope of the first oil storage part 121 may be formed in such a way that a thickness of the partition 120 increases in the direction in which it is away from the cage main body 110.

In this way, since the first oil storage part 121 is formed with a slope, oil may be stably received and stored in the first oil storage part 121.

An angle of inclination of the slope of the first oil storage part 121 with respect to the axis may be 5° or less. When the angle of inclination exceeds 5°, a space for storing oil becomes too small, making it difficult to fully achieve the effect of storing and supplying oil.

According to an example embodiment of the present disclosure, the second oil storage part 122 may also have the same configuration as the first oil storage part 121. That is to say, the second oil storage part 122 may be formed on the inner surface of the partition 120 and may be formed to have an inclined surface. Specifically, the second oil storage part 122 may be formed to be inclined in the direction in which it is away from the cage main body 110 with respect to the axial direction. More specifically, the second oil storage part 122 may be formed so that an internal space becomes smaller in the direction in which it is away from the cage main body 110 in the axial direction. In other words, the slope of the second oil storage part 122 may be formed in such a way that the thickness of the partition 120 increases in the direction in which it is away from the cage main body 110.

The angle of inclination of the slope of the second oil storage part 122 with respect to the axis may be 5° or less, as in the first oil storage part 121. Therefore, oil may be stably received and stored on the inner side of the partition 120 through the second oil storage part 122.

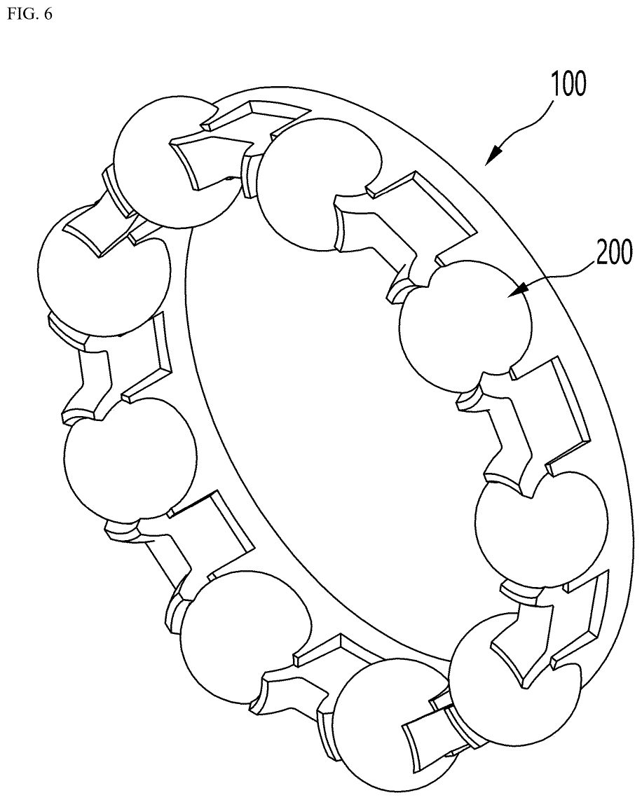

FIG. 6 exemplarily shows balls supported in the cage according to an example embodiment of the present disclosure. As shown in the drawing, the ball 200 is seated in the pocket 140 of the cage 100 and the position of the ball 200 is supported by the cage 100 when the ball bearing rotates. According to an example embodiment of the present disclosure, the oil storage parts 121 and 122 formed in the partition 120 are configured to store oil and supply oil to the rotating ball when the ball bearing is driven and also to collect oil when driven.

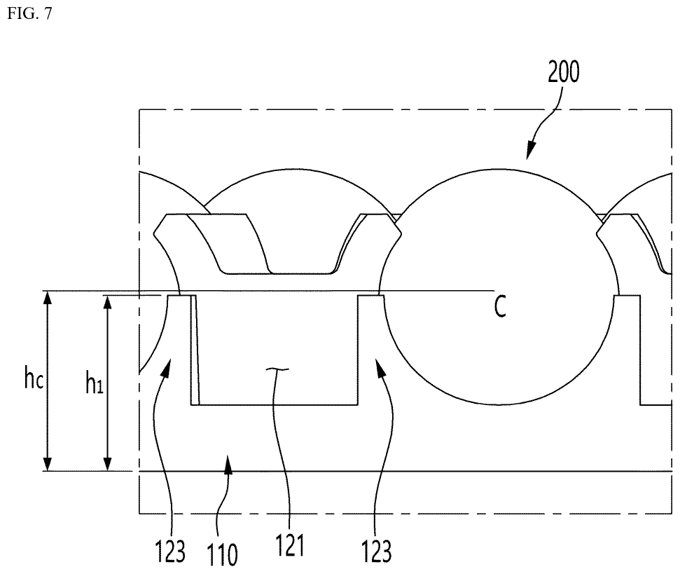

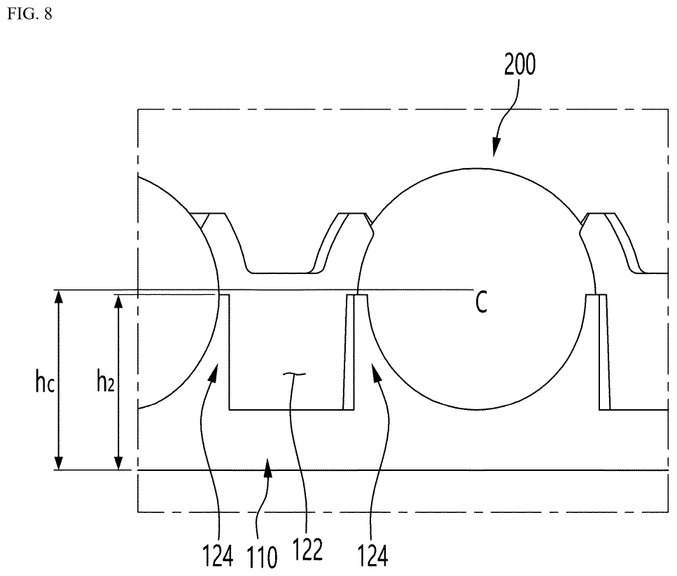

FIG. 7 exemplarily shows the partition of the cage according to an example embodiment of the present disclosure when viewed from the outside and FIG. 8 exemplarily shows the partition of the cage according to an example embodiment of the present disclosure when viewed from the inside.

First, referring to FIG. 7, first lateral walls 123 may be formed on both sides adjacent to the pocket 140 on an outer surface of the partition 120 and the first oil storage part 121 may be defined by the cage main body 110 and the first lateral walls 123. Subsequently, referring to FIG. 8, second lateral walls 124 may be formed on both sides adjacent to the pocket 140 on an inner surface of the partition 120 and the second oil storage part 122 may be defined by using the cage main body 110 and the second lateral walls 124.

According to an example embodiment of the present disclosure, a height h1 of the first oil storage part 121, a height h2 of the second oil storage part 122, and a height hc of a ball center C may be defined on the basis of a bottom surface of the cage main body 110. Specifically, a distance from the bottom surface of the cage main body 110 to an end portion of the first lateral wall 123 which partitions the first oil storage part 121 is defined as the height h1 of the first oil storage part 121, a distance from the bottom surface of the cage main body 110 to an end portion of the second lateral wall 124 which partitions the second oil storage part 122 is defined as the height h2 of the second oil storage part 122, and a distance from the bottom surface of the cage main body 110 to the center C of the ball 200 may be defined as the height hc of the ball center C.

According to an example embodiment of the present disclosure, the height h1 of the first oil storage part 121 may be formed smaller than the height hc of the ball center C. Furthermore, the height h2 of the second oil storage part 122 may also be formed smaller than the height hc of the ball center C.

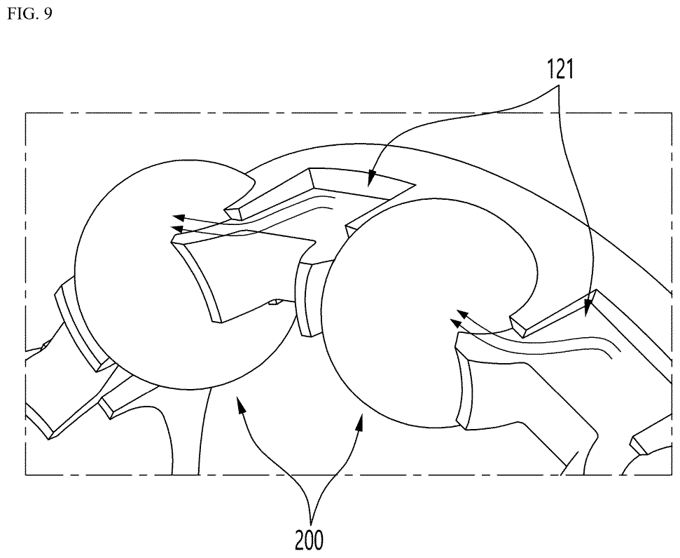

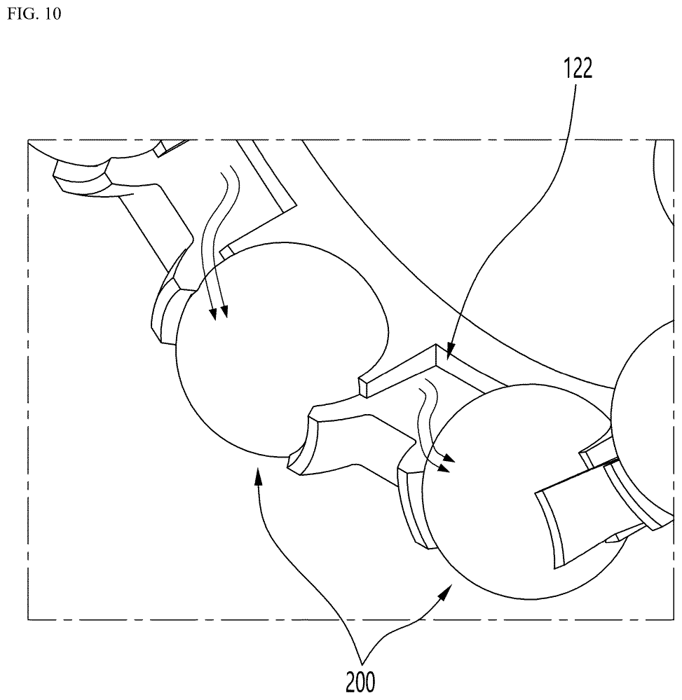

FIG. 9 exemplarily shows lubrication performed on an outer side of the partition of the cage according to an example embodiment of the present disclosure and FIG. 10 exemplarily shows lubrication performed on an inner side of the partition of the cage according to an example embodiment of the present disclosure.

First, referring to FIG. 9, oil stored in the first oil storage part 121 may be supplied to the ball 200 through an end portion of the first lateral walls 123 when the ball bearing rotates. Specifically, an oil flow path may be formed between the first oil storage part 121 and the pocket 140 at the end portion of the first lateral walls 123 and oil may be supplied from the first oil storage part 121 to the ball 200 through this oil flow path.

Subsequently, referring to FIG. 10, as in FIG. 9, oil stored in the second oil storage part 122 may be supplied to the ball 200 through the end portion of the second lateral walls 124 when the ball bearing rotates. Specifically, an oil flow path may be formed between the second oil storage part 122 and the pocket 140 at the end portion of the second lateral walls 124 and oil may be supplied from the second oil storage part 122 to the ball 200 through this oil flow path.

On the other hand, when the height h1 of the first oil storage part 121 and the height h2 of the second oil storage part 122 are greater than the height hc of each ball center C, when the ball bearing rotates, the oil stored in the first oil storage part 121 and the second oil storage part 122 may be supplied only to a part of the ball 200, that is, to the upper part of the ball centered on the drawing, through the end portions of the first lateral walls 123 and the second lateral walls 124, respectively. Here, in an example embodiment of the present disclosure, by forming the height h1 of the first oil storage part 121 and the height h2 of the second oil storage part 122 smaller than the height hc of each ball center C, the oil stored in the first oil storage part 121 and the second oil storage part 122 may be smoothly supplied to the entire ball 200 through the end portions of the first lateral walls 123 and the second lateral walls 124, respectively, when the ball bearing rotates.

As described above, according to an example embodiment of the present disclosure, the oil storage parts 121 and 122 are configured to store oil and supply oil to a ball which rotates when the ball bearing is driven. Particularly, the oil storage parts 121 and 122 may perform an initial oil supply function before oil is supplied from the outside when the ball bearing starts to rotate after being in a non-rotating state, for example, at the time of starting an electric vehicle (that is, when the electric motor is driven).

Generally, it may take some time for an electric motor to start operating and for oil to be supplied from the outside, and during that time, friction may occur significantly due to the lack of oil supply and damage to the raceway surface and balls may occur due to frictional heat. Here, according to an example embodiment of the present disclosure, the oil storage parts 121 and 122 of the cage 100 may store oil even when the ball bearing is not rotating and supply oil immediately when it starts rotating, thereby reducing friction and preventing damage due to friction.

On the other hand, according to an example embodiment of the present disclosure, the ball bearing including the cage described above may be provided. Specifically, the ball bearing according to an example embodiment of the present disclosure may comprise an inner ring, an outer ring disposed opposite the inner ring, a plurality of balls disposed between the inner ring and the outer ring and spaced apart from each other by a predetermined interval, and a cage disposed between the inner ring and the outer ring and configured to maintain the plurality of balls by a predetermined interval. Configurations of the inner ring, the outer ring, and the ball of the ball bearing are the same as the generally known configurations and the configuration of the cage is same as described above. Such a ball bearing according to an example embodiment of the present disclosure is particularly suitable for use at high speeds.

Although the present disclosure has been described with specific details such as specific components and limited examples, the examples are provided only to help a more general understanding of the present disclosure and the present disclosure is not limited thereto and a person having ordinary knowledge in the technical field to which the present disclosure belongs may make various modifications and variations from this description.

Therefore, the idea of the present disclosure need not to be limited to the embodiments described above and not only the claims which will be described below but also all modifications equivalent to or equivalent to the claims are considered to fall within the scope of the idea of the present disclosure.

### EXPLANATION OF REFERENCE NUMERALS

100 Cage
110 Cage main body
120 Partition
121 First oil storage part
122 Second oil storage part
123 First lateral wall
124 Second lateral wall
130 Ball support part
140 Pocket
150 Weight loss part
200 Ball

### INDUSTRIAL APPLICABILITY

According to the present disclosure, it is possible to improve lubrication by smoothly supplying lubricating oil even when a ball bearing rotates at high speed. Particularly, according to the present disclosure, it is possible to supply oil stored in an oil storage part to the ball even at the initial stage of starting, thereby reducing friction and suppressing the generation of frictional heat.

Also, according to the present disclosure, by reducing a weight of a cage for a ball bearing, it is possible to reduce a centrifugal force even when the ball bearing rotates at high speed, thereby preventing cage deformation.

What is claimed is:

1. A case (100) for a ball bearing, comprising:
a cage main body (110) formed to have a ring shape;
a plurality of partitions (120) which each extend in an axial direction of the cage main body (110) and are formed spaced apart in a circumferential direction of the cage main body (110); and
ball support parts (130) which are formed to extend in the axial direction from an opposite end portion of the cage main body (110) in each of the plurality of partitions (120),
wherein pockets (140) are formed between the plurality of partitions (120) adjacent to each other so that a ball is seated therein, and
oil storage parts (121) and (122) are formed on at least one of an outer surface and an inner side in a radial direction of the plurality of partitions (120) so that oil stored in the oil storage parts (121) and (122) is supplied to the pocket (140).

2. The case for a ball bearing of claim 1, wherein the oil storage part (121) and (122) has an inclined surface inclined in a direction in which it is away from the cage main body (110).

3. The case for a ball bearing of claim 2, wherein the inclined surface of the oil storage part (121) and (122) is formed in such a way that a thickness of the partition (120) increases in the direction in which it is away from the cage main body (110).

4. The case for a ball bearing of claim 3, wherein an angle of inclination of a slope of the oil storage part (121) and (122) with respect to the axial direction is 5° or less.

5. The case for a ball bearing of claim 1, wherein a pair of lateral walls (123) and (124) are formed on at least one of an outer surface and an inner side in the radial direction of the plurality of partitions (120) and disposed to be spaced apart in the circumferential direction, and
the oil storage parts (121) and (122) are defined by the cage main body (110) and the pair of lateral walls (123) and (124).

6. The case for a ball bearing of claim 5, wherein heights h1 and h2 of the oil storage parts (121) and (122) which are defined as a distance from a bottom surface of the cage main body (110) to end portions of the pair of lateral walls (123) and (124) are formed smaller than a height hc of a ball center C which is defined as a distance from the bottom surface of the cage main body (110) to the center C of the ball (200) which is seated in the pocket (140).

7. The case for a ball bearing of claim 1, wherein first oil storage parts (121) are formed on the outer surface in the radial direction of the plurality of partitions (120) and second oil storage parts (122) are formed on the inner surface in the radial direction of the plurality of partitions (120).

8. The case for a ball bearing of claim 1, further comprising:
a weight loss part formed as a groove in the circumferential direction on a bottom surface of the cage main body (110).

9. A ball bearing, comprising:
an inner ring;
an outer ring which is disposed opposite the inner ring;
a plurality of balls which are disposed between the inner ring and the outer ring and spaced apart from each other at a predetermined interval; and
a cage which is disposed between the inner ring and the outer ring and configured to maintain the plurality of balls at a predetermined interval,
wherein the cage (100) comprises:
a cage main body (110) formed to have a ring shape;
a plurality of partitions (120) which each extend in an axial direction of the cage main body (110) and are formed spaced apart in a circumferential direction of the cage main body (110); and
ball support parts (130) which are formed to extend in the axial direction from an opposite end portion of the cage main body (110) in each of the plurality of partitions (120),
wherein pockets (140) are formed between the plurality of partitions (120) adjacent to each other so that a ball is seated therein, and
oil storage parts (121) and (122) are formed on at least one of an outer surface and an inner side in a radial direction of the plurality of partitions (120) so that oil stored in the oil storage parts (121) and (122) is supplied to the pocket (140).
